(19) United States
(12) Patent Application Publication
(10) Pub. No.: US 2008/0077879 A1
(43) Pub. Date: Mar. 27, 2008

(54) Interface with multiple rows of tabs having tabs at fixed relative positions

(76) Inventor: Andre B. Black, Revere, MA (US)

Correspondence Address: FISH & RICHARDSON PC, P.O. BOX 1022, MINNEAPOLIS, MN, 55440-1022, US

(21) Appl. No.: 11/527,168

(22) Filed: Sep. 25, 2006

(51) Int. Cl. G06F 9/00; G06F 17/00

(52) U.S. Cl. 715/784; 715/785; 715/786; 715/787; 715/777; 715/798; 715/800; 715/810

(57) ABSTRACT

A method that includes presenting in a first area of a graphical interface a plurality of graphical items arranged in one or more sequences of graphical items, each of the graphical items associated with a set of data items, with the plurality of graphical items arranged in a fixed relative order for a particular size of the first area, with a first graphical item in one sequence always being spatially adjacent to a second graphical item in the one sequence, and with another sequence of the one or more sequences of graphical items being spatially adjacent to the same sequence of graphical items preceding the another sequence of graphical items.

### TECHNICAL FIELD

This invention relates to graphical interfaces.

### BACKGROUND

Graphical user interfaces often use “tabs”, e.g., graphical icons to control and/or present information in a structured and compact manner. A tab graphical icon is based on the metaphor of using dividers in filing cabinets. A user who wishes to access information contained in a particular divider of a filing cabinet locates the particular divider by locating the corresponding tab and physically pulling that divider out of the cabinet. Similarly, tabbed graphical interfaces enable a user to click or otherwise select a tab icon, or some other icon (e.g., radio buttons), to cause the interface to present information corresponding to the selected tab.

While graphical icons such as tabs offer a convenient way of organizing data and product functions, a typical problem encountered by users of tabbed graphical interfaces is that it is often difficult to locate a desired tab. This is especially a problem when the graphical interface includes a large number of such tabs and the positions of the tabs shift when a tab is selected because the locations of the tabs on the graphical interface are re-shuffled. Consequently, a user may find it difficult to browse through other tabs on the interface because the locations of the of the tabs are changing each time a tab is selected.

### SUMMARY

Disclosed herein are methods, systems and computer program products for causing graphical items, such as tabs, to maintain their relative positions with respect to each other fixed, so that the sequential order of tabs when following, for example, a left-to-right path and bottom-to-top row progression, remains unchanged even when the size of the interface on which the tabs are presented changes.

In one aspect, disclosed is a method that includes presenting in a first area of a graphical interface a plurality of graphical items arranged in one or more sequences of graphical items, each of the graphical items associated with a set of data items, with the plurality of graphical items arranged in a fixed relative order for a particular size of the first area, with a first graphical item in one sequence always being spatially adjacent to a second graphical item in the one sequence, and with another sequence of the one or more sequences of graphical items being spatially adjacent to the same sequence of graphical items preceding the another sequence of graphical items.

Embodiments may include one or more of the following.

The method may further include presenting a copy of the selected graphical item in a second area of the graphical interface in response to a selection of one of the plurality of graphical items. The method may further include indicating that the selected graphical item has been selected. Each of the plurality of the graphical items may be associated with a corresponding opaqueness value, and indicating that the selected graphical item in the first area of the graphical interface has been selected may includes changing the opaqueness value associated with the selected graphical item. Changing the opaqueness value associated with the selected graphical item may include decreasing the opaqueness value.

Each of the plurality of graphical items may be represented as a corresponding tab. The one or more sequences of graphical items may be represented as rows of tabs.

The method may further include presenting in a third area of the graphical interface, in response to the selection of the one of the plurality of graphical items, the corresponding set of data items associated with the selected graphical item. The copy of the selected graphical item presented in the second area of the graphical interface and the corresponding set of data items presented in the third area may be represented as a page having a tab.

Each corresponding set of data items may include, for example, a text paragraph, a hyperlink, an image, a text entry field, and/or a graphical radio button.

The method may further include causing one or more graphical items to be re-positioned, in response to a re-sizing operation performed on the interface, with the respective relative sequential positions of the graphical items, following a particular path that starts from a particular graphical item, remaining fixed. The path may includes, for example, a row-by row progression, and/or a column-by-column progression.

Presenting in the first area of the graphical interface may include displaying in a display area of an Internet browser, and causing one or more graphical items to be re-positioned may include a) detecting an occurrence of a browser re-sizing event, b) determining the coordinates of the one or more graphical items to be re-positioned computed by the browser, and c) adjusting the respective coordinates for at least some of the one or more graphical items to be re-positioned.

The method may further include causing one or more graphical items positioned at the end of a particular sequence of graphical items to be positioned, in response to performing a re-sizing operation on the graphical interface, at the beginning of another sequence of graphical items positioned adjacent to the particular sequence of graphical items.

The one or more sequences of graphical items may be represented as rows of tabs, and causing the one or more graphical items positioned at the end of a particular sequence of graphical items to be positioned at the beginning of another sequence of graphical items may include causing one or more tabs positioned at the right-end of the particular row of tabs to be positioned at the left-end of a row of tabs located above the particular row of tabs.

In another aspect, disclosed is a method that includes presenting in a first area of a graphical-user-interface (GUI) a plurality of tabs arranged in one or more rows of tabs, each of the tabs associated with a corresponding set of data items, with the plurality of tabs arranged in a fixed relative order to each other for a particular size of the first area, with a tab in one row always being spatially adjacent to a second tab in the one row, and with another row of the one or more rows of tabs being spatially adjacent to the same row of tabs preceding the another row of tabs.

In a further aspect, disclosed is a computer program product residing on a machine-readable storage medium for storing computer instructions that, when executed, cause a processor-based machine to present in a first area of a graphical interface a plurality of graphical items arranged in one or more sequences of graphical items, each of the graphical items associated with a set of data items, with the plurality of graphical items arranged in a fixed relative order for a particular size of the first area, with a first graphical item in one sequence always being spatially adjacent to a second graphical item in the one sequence, and with another sequence of the one or more sequences of graphical items being spatially adjacent to the same sequence of graphical items preceding the another sequence of graphical items.

In yet another aspect, disclosed is a system that includes a display device, a memory module configured for storing instructions, and a processor. The processor is configured to fetch and execute the instructions, and, in response to executing the instructions, present in a first area of a graphical interface a plurality of graphical items arranged in one or more sequences of graphical items, each of the graphical items associated with a set of data items, with the plurality of graphical items arranged in a fixed relative order for a particular size of the first area, with a first graphical item in one sequence always being spatially adjacent to a second graphical item in the one sequence, and with another sequence of the one or more sequences of graphical items being spatially adjacent to the same sequence of graphical items preceding the another sequence of graphical items.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIG. 1 is an exemplary embodiment of a computing system that supports executing graphical user interfaces with tabs having fixed relative positions.

FIG. 2 is an exemplary embodiment of a graphical interface that includes a plurality of graphical items.

FIG. 3 is another embodiment of an exemplary graphical interface having a plurality of graphical items.

FIG. 4A is a schematic of tab arrangement that includes tabs arranged in accordance with one particular relative positioning scheme.

FIG. 4B is a schematic of a subsequent tab arrangement resulting from a change of size of the tabs area of FIG. 3A.

FIG. 5 is a flowchart of an exemplary embodiment of a procedure for performing tab line-wrapping on a graphical interface in which the tabs maintain their fixed relative positions.

FIGS. 6A-6D show an exemplary embodiment of an interface being re-sized, and having its respective tabs re-positioned.

### DETAILED DESCRIPTION

Disclosed herein are interfaces, methods and systems in which a plurality of tabs, or other types of graphical items, arranged in one or more rows of tabs are presented in a first area of a graphical-user-interface (GUI). Each of the tabs is associated with a corresponding set of data items, with the plurality of tabs arranged in fixed relative positions such that, for a particular size of the first area of the GUI, a tab in one row is always spatially adjacent to a second tab in that one row, and such that one row of tabs is always spatially adjacent to the same row of tabs next to it. Such an arrangement of tabs preserves the relative position of the tabs with respect to each other, enabling a user to easily locate a particular tab from amongst the plurality of tabs presented on the interface. A user can develop a recollection with respect to the tab arrangement to quickly move to a different tab without having to go through a protracted process of locating a particular tab on the graphical interface.

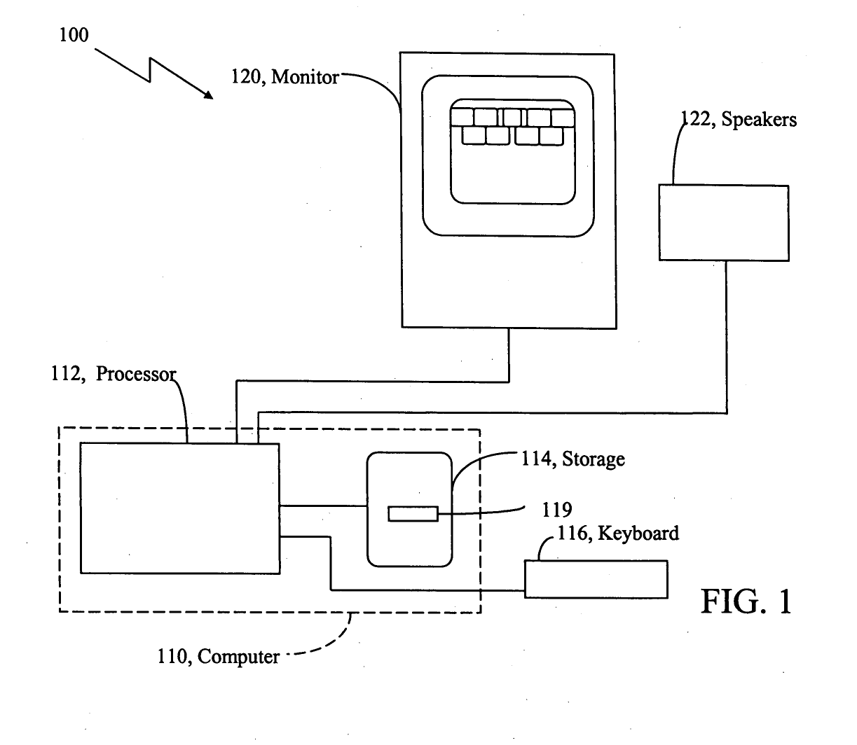

Referring now to FIG. 1, a computing system 100, such as a personal computer; a personal digital assistant, a specialized computing device or a reading machine and so forth, includes a computer system 110. The computer system 110 is generally a personal computer or can alternatively be another type of computer and typically includes a central processor unit 112. The computer system 110 may include a computer and/or other types of processor-based devices suitable for multiple applications. In addition to the CPU 112, the system includes main memory, cache memory and bus interface circuits (not shown). The computer system 110 includes a mass storage element 114, here typically the hard drive associated with personal computer systems. The computing system 100 further includes a keyboard 116, a monitor 120 or other type of a display device.

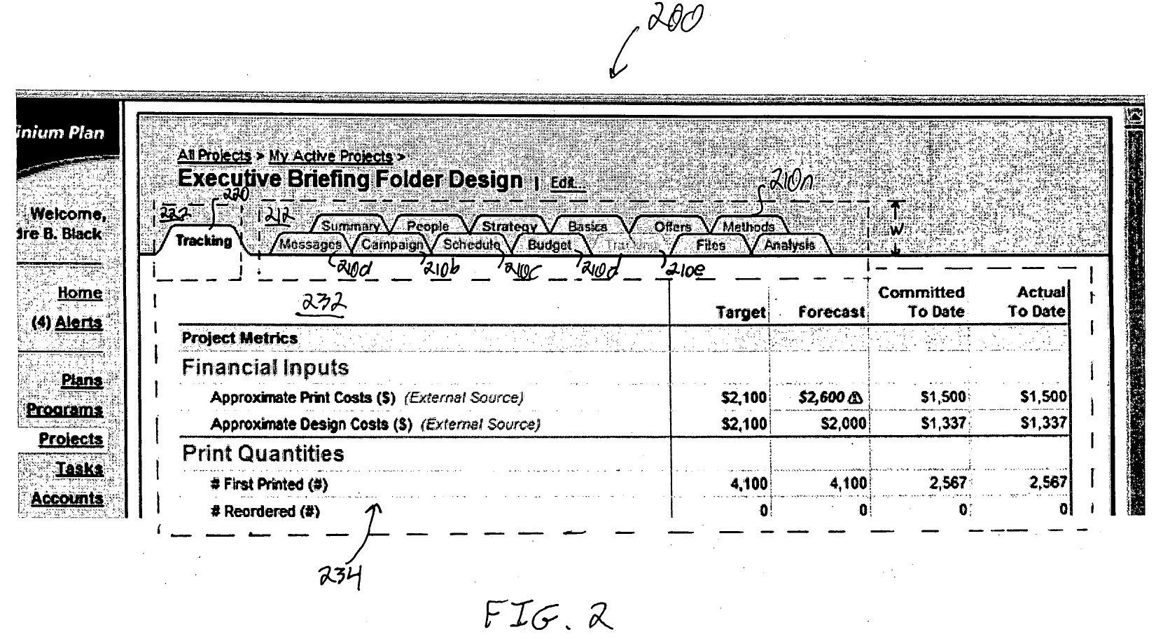

As will become apparent below, the computing system 100 is configured to render on the monitor 120 a graphical interface having a plurality of tabs that are arranged in one or more rows, and which maintain their position fixed relative to each other, even when the size of the displayed interface is modified (for example, in response to a re-sizing operation effected by a user interacting with the computer system 110). The storage device 114 may include a computer program product that when executed on the computer system 110 results in a graphical interface having fixed relative position tabs to be rendered on the monitor 120, as will be described in FIGS. 2-6 below.

In some implementations the computer can include speakers 122, a sound card (not shown), and a pointing device such as a mouse 119 all coupled to various ports of the computer system 110, via appropriate interfaces and software drivers (not shown). The computer system 110 includes an operating system, e.g., Windows XP® Microsoft Corporation operating system. Alternatively, other operating systems could be used.

In some embodiments, the interfaces with the tabs having fixed relative positions is implemented on an Internet browser, such as Internet Explorer™, and thus, the entire presentation of the interface is rendered within the display area of the browser. To implement the interface on an Internet browser, the content of the interface, including the interface's tabs, is specified using, for example, Semantic HTML syntax. Cascading style sheets can be used to control the appearance of the tabs of the interface, and JavaScript can be used to control the behavior and operation of the interface, including the tab line-wrapping behavior and operations of the tabs when the browser, in which the interface is rendered, is re-sized. Alternatively, the interface can be implemented, for example, as an application window operating on a MS-Windows platform, or any other type of platform that enables presentation of graphical user interfaces. In circumstances where the interface is implemented as a window, the interface can be designed and presented using suitable programming languages and/or tools, such as Visual Basic, that support the generation and control of such interfaces.

Referring to FIG. 2, an exemplary embodiment of a graphical interface 200 that includes a plurality of graphical items, such as tabs 210a-210n, presented in a first area 212 of the interface 200 is shown. As can be seen, the tabs 210a-210n are arranged in one or more sequences of tabs. In the embodiment shown in FIG. 2, the sequences of tabs are an arrangement of rows of tabs. However, the tabs 210a-210n (or other types of graphical items) can be arranged as columns of tabs, or in any other suitable sequential arrangement. Each of the tabs 210a-210n is associated with a corresponding set of data items. Such data items include textual and graphical content that is presented upon the selection of a particular tab. Such data items can also include hyperlinks to access content on a local or remote network (e.g., hyperlink to websites as identified by a Uniform Resource Locator), text entry fields to enable users to enter data, graphical icons that enable the user to enter input (e.g., radio buttons), etc.

The tabs 210a-210n are arranged so that their order relative to each other is fixed. Thus, a graphical item in one sequence of graphical items is always spatially adjacent to a second graphical item in that sequence for a particular size. Further, where the first area 212 includes more than one sequence of graphical items, one sequence will always be spatially adjacent to the same sequence next to it (e.g., the sequence of graphical items preceding it). For example, as shown in FIG. 1, the tab 210b (the tab identified as “Campaign”) will always be positioned next to the tabs 210a and 210c so long that the first area 212 remains of the same size, e.g., width “W” of the first area. Similarly, the top row of tabs which includes tab 210n (identified as “Methods”) will always be spatially adjacent to the lower row of tabs as long as the size of the area 212 remains the same. As the size of area 212 (e.g., width W) changes as a result of a re-sizing operation of the GUI 200, the actual location of the tabs 210a-210n in the re-sized tabs area 212 will change, but the order of those tabs relative to each other, for example, when following a left-to-right path within a row, and a bottom-to-top path from one row to the next, will remain fixed.

To select a particular tab, a user interacting with the interface 200 clicks on the particular tab or otherwise causes the particular tab to be selected. In response to the selection of the tab, a copy of the selected tab 220, optionally in a format that is different than that of the original selected tab in the tabs area 212, is presented in a second area 222 of the user interface 200. The tab 220, identified as “Tracking” is presented in the second area 222 in a format in which its size, e.g., length and width are each larger than the corresponding dimensions the corresponding selected tab 210e which appears in tabs area 212.

As further shown, the original selected tab, e.g., tab 210e, that appears in the tabs area 212 remains in its current location, with all the other tabs in the tabs area maintaining their positions. The tabs 210a-210n are not shifted from their positions or otherwise have their positions relative to the other plurality of tabs in the tabs area 212 changed. Additionally, the selected tab from the tabs area 212 is formatted, or otherwise manipulated, to indicate that that tab has been selected. For example, the opaqueness of the tab can be decreased to make the tab appear more faded or transparent compared to the other tabs appearing in the tabs area 212, to enable a user to quickly identify what tab is active by simply viewing the tabs area 212. Indicating which tab has been selected, and is thus active, can also be done by changing other properties of the selected tab's format and/or configuration.

Upon the selection of a tab, the set of data items 234 associated with the particular selected tab is presented in a third area 232 of the interface 200. In the example shown in FIG. 2, the set of data items 234 includes data arranged in a table. Thus, in this example, the content page, for the “Tracking” tab 220 includes textual and graphical data. As noted above, the content (i.e. data items) associated with other tabs could include hyperlinks, data entry fields, etc.

To enable a user to more clearly associate between the data item presented in the area 232 and the tab corresponding to those data items, the copy of the tab 220 appearing in the second area 222 is presented in such a way that the second area 222 and the third area 232 appear contiguous and integral. In the example shown in FIG. 2, the third area 232 and the content presented therein appear immediately underneath the tab 220, resulting in the tab 220 and the corresponding set of data items to be represented as a page having a tab.

The graphical items, for example tabs, presented in a graphical interface, such as the interface 200, are arranged in a fixed, relative position with respect to one or more other tabs. So long that the size of the tabs area (e.g., first area 212 in FIG. 2) remains the same, the tabs 210a-210n relative positions remain fixed, as do the tabs' absolute positions. Thus, the selection of any of the tabs 210a-210n may result in the selected tab changing its appearance characteristics (e.g., becoming less opaque than the other tabs in area 212), but otherwise the tabs position will not change. However, once the size of the area 212 changes, for example, in response to a re-sizing operation of the interface 200, the tabs' absolute positions will change, but the tabs' position relative to other tabs will remain the same. In some embodiments, the tabs' fixed relative position will be such that the tabs sequential order when following a left-to-right path within a row, and a bottom-to-top path from one row to another, does not change. Other paths in which a fixed relative order is maintained may also be used.

As noted above, where the interface is presented on an Internet browser, the content and manner of presentation of the elements appearing in the interface can be controlled, for example, using semantic HTML (to specify the content), and cascading style sheets to specify the manner in which the content is presented. Thus, to make a selected tab in the tab area 212 have a less opaque appearance, the presentation properties associated with that tab element can be adjusted on the corresponding cascading style sheet.

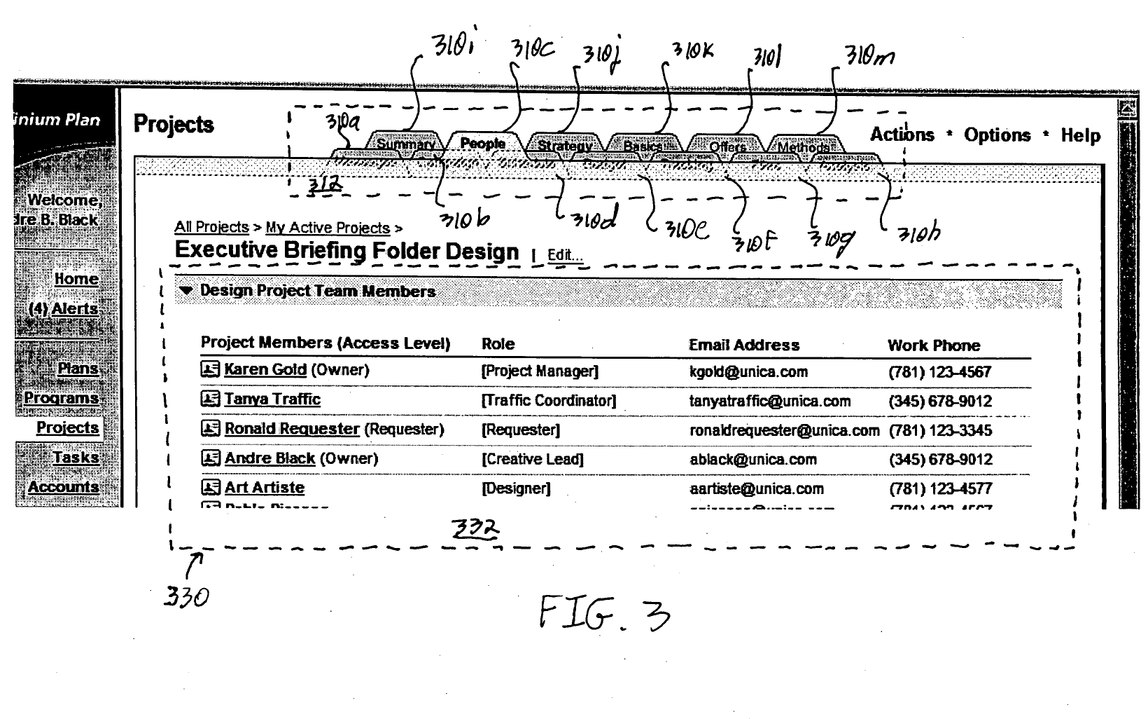

Referring to FIG. 3, another embodiment 300 of an exemplary interface having a plurality of tabs 310a-310m that are arranged in fixed relative positions with respect to one or more other tabs is shown. In the embodiment of FIG. 3, selecting a particular tab, for example tab 310c (identified as “People”) causes that selected tab to be more prominently displayed, enabling the user interacting with the interface to distinguish the selected tab from the non-selected tabs. In the embodiment of FIG. 3, the non-selected tabs have a darkened appearance, with some of the non-selected tabs being partially obscured by the prominently displayed semi-transparent selected tab's header area.

Selection of the particular tab also causes the set of data items corresponding to the selected tab to be displayed. Thus, as shown in FIG. 3, the set of data item 330, corresponding to the selected People tab 310c, is presented in area 332.

Unlike interface 200 shown in FIG. 2, the interface 300 does not include an area where a copy of the selected tab is presented. Rather, a user can determine which tab is selected based on the appearance of the selected tab in the area 312 of the interface.

However, as with interface 200, selection of a particular tab will not cause the tabs' relative positions to change. Thus, regardless of which tab is selected, the tabs will maintain their relative positions with respect to one or more of the other tabs for a particular size of the area 312. Accordingly, a tab in one row of tabs will always be spatially adjacent to a second tab in that row for the particular size of the area 312. Further, where the area 312 includes more than one row of tabs, one row will always be spatially adjacent to the same row next to it (e.g., the row of tabs preceding it).

Other interface configurations and ways of displaying selected and non-selected graphical items (e.g., tabs), and in which the graphical items maintain their relative positions with respect to one or more other graphical items for a given size of the tabs area, may be used.

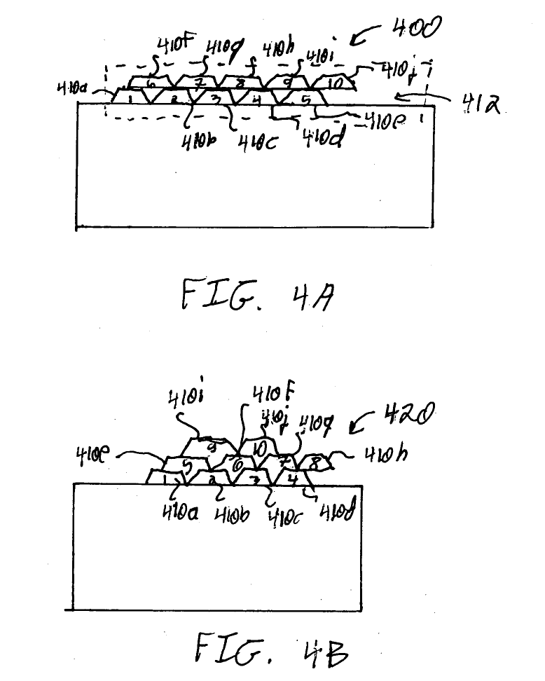

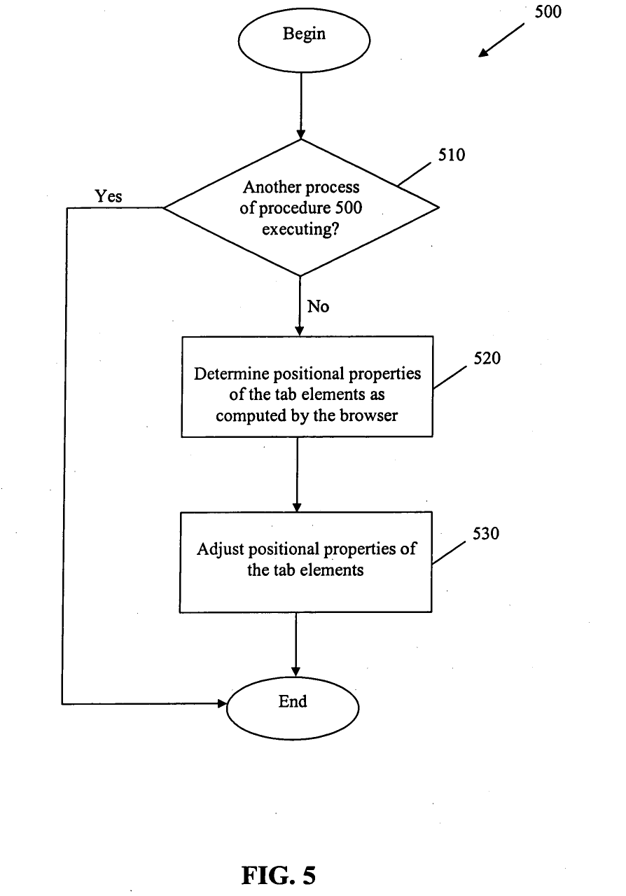

The fixed relative positions of the tabs can be defined in various ways when the size of the tabs area changes. FIG. 4A is a schematic of tab arrangement 400 that includes tabs 410a-410j arranged in accordance with one particular relative positioning scheme. For the purpose of illustration, the tabs are numbered 1-10. In the embodiment of FIG. 4A, the tabs' fixed relative position is such that the tabs maintain their sequential order with respect to a given tab. Particularly, assuming for the purpose of illustration that tab 1 (i.e., tab 400a) is the first tab of in the arrangement of tabs shown in FIG. 4A, then the sequential position of another tab, following a particular path (or progression order) that proceeds from a particular tab, will always be the same. For example, in FIG. 4A tab 410g (i.e., tab 7) will always be the seventh (7^{th}) tab in the tab arrangement 400 when traversing the tab arrangement 400 following a left-to-right path and bottom-to-top row progression.

FIG. 4B is a schematic of the tab arrangement 420 resulting from a change of size of the tabs area 412 in which the tabs 410a-410j are arranged. As can be seen, in the tab arrangement 420 the tabs 410a-410j are arranged in three rows rather than the two rows of arrangement 400. The arrangement 420 could have resulted, for example, from a re-sizing operation of the interface. Although the absolute position of the tabs 410a-410j on the interface has changed in relation to arrangement 400, the relative positions of the tabs 410a-410j with respect to any given tab (e.g., tab 410a) has remained the same as it was in arrangement 400. Particularly, when traversing the tab arrangement 420 on a row-by-row basis from bottom to top and from left to right within rows, starting from tab 410a, tab 410g remains the seventh tab reached following this path, as it was for the arrangement 400 of FIG. 4A.

Other ways of defining the relative position of tabs may be used. For example, in some embodiments, the fixed relative positions of tabs with respect to one or more other tabs may be defined such that the tabs' order remains fixed when a column-by-column path is followed.

FIGS. 4A and 4B also illustrate that in some embodiments, to maintain their fixed relative positions, the tabs will be re-positioned in the tabs area in response to a change in the size of the tabs area (e.g., area 412). For example, in some embodiments, a decrease of the size of the tabs area will cause the tabs to be line-wrapped so that one or more tabs that are positioned at the far end of a particular row of tabs will be shifted to the beginning of the row of tabs that is adjacent to the particular row of tabs. If the interface originally had only a single row of tabs, a re-sizing of the tabs area may result in the formation of a new row of tabs that includes one or more tabs moved from the end of the original row to the beginning of the new row. If the far-most right tab of the original row is moved to a new row, it will thus become the far-most left tab in the newly formed row.

If the interface already included more than one row of tabs, a re-sizing of the tabs area will cause the far most tabs from a first row to be moved to the beginning of the adjacent row of tabs, shifting the tabs originally placed in the adjacent row so that the previous first tab of the adjacent row (i.e., prior to the re-sizing operation) will be positioned next to the far-most tab moved from the first row.

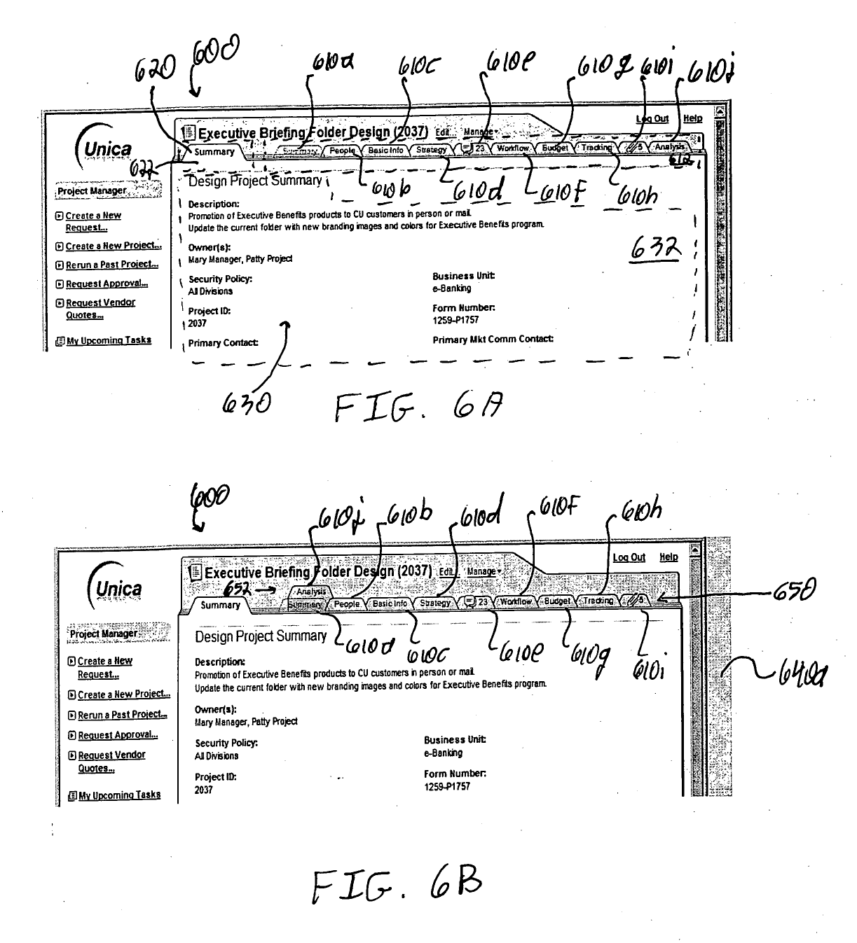

FIG. 5 is a flowchart of an exemplary embodiment of a tab line-wrapping procedure 500, for use with an interface presented on an Internet browser such as Microsoft Internet Explorer™, for causing the tabs to be re-arranged while maintaining their relative positioning with respect to the other tabs. The tab line-wrapping procedure 500 can be implemented using Java script, or using other suitable software programming language and/or tools. Invocation of the procedure 500 pre-empts some default procedures (e.g., cutting off some of the display content, including displayed tabs, from the display area of the browser) performed by the Internet browser when a re-sizing operation is performed.

The procedure 500 is triggered and commences operation by the browser's internal event firing mechanism. In response to the occurrence of a re-sizing operation, the browser will cause the procedure 500 to be launched. In some embodiments, the procedure 500 is launched after some pre-determined delay (e.g., 0.25 seconds) from the time the re-sizing event is triggered.

The occurrence of the re-sizing event could result in the invocation of multiple processes corresponding the procedure 500. To ensure that the occurrence of the re-size event does not cause an unmanageable number of such processes to constantly be launched, procedure 500 determines at 510 whether a process corresponding to procedure 500 is already executing. Particularly, when a process corresponding to procedure 500 is invoked, one or more flags (e.g., the alreadyStarted flag) is set. Such a flag indicates that an earlier invoked process corresponding to procedure 500 is already executing. Setting this flag thus prevents the processor from launching another process (or thread) corresponding to procedure 500 so long that the appropriate flag is set. Accordingly, if a launched process corresponding to procedure 500 determines that another process corresponding to procedure 500 is already executing (e.g., by determining the value of the alreadyStarted flag), that process is terminated.

Upon completion of a full function execution, the flag that indicates that some process corresponding to procedure 500 is already executing is reset. Once this flag is reset, another process, corresponding to procedure 500, can be invoked and executed if the re-sizing event is still on, or if a new re-sizing event has been triggered. Such intermittent flag resetting operation thus results in intermittent execution of procedure 500, which in turn results in the computation of intermediate positions for the line-wrapped tabs. For example, in some circumstances, a user re-sizing the interface may waver on the desirable dimensions of the interface, and thus it may take several seconds before the user settles on the desirable size of the interface. During this time, when the user continues to adjust the dimensions of the browser (and thus the dimensions of the interface) the tabs are intermittently re-positioned to intermediate locations based on the current size of the interface at the time when the procedure 500 that computed the resultant intermediate tabs' positions was launched.

In some embodiment, to line-wrap the tabs so that they maintain their relative positioning, as shown, for example, in FIGS. 4A and 4B, the tabs are defined as part of a styled unordered list object. Defining the tabs as part of a list object, and then styling that list with text floating instructions, will cause the Internet browser on which the interface is displayed to treat the tabs very much like text elements. The default operation performed by some Internet browsers on text elements, in response to a re-sizing operation, is to cause the text to line-wrap. For example, text portions appearing at the end of a particular line in the display area of the browser will be wrapped to the left-most part of the next line (i.e., at a lower vertical position than where the text appeared prior to the re-sizing) in response to a re-sizing operation. Thus, during normal operation, the Internet browser maintains the relative positioning of displayed text with respect to other text portions. Accordingly, the procedure 500 can use the browser's treatment of text objects to similarly maintain the relative positioning of tabs when tabs have to be line-wrapped in response to a re-sizing operation.

Therefore, after a browser re-sizing event has occurred and the procedure 500 has been invoked, the procedure 500 determines at 520 the positional properties of the tabs. Particularly, the re-sizing operation of the browser, and the browser's treatment of the tabs as text content (for example, by defining the tabs as a list object using Semantic HTML), causes the browser to compute the subsequent vertical and horizontal positioning of the tab content in the display area. The computed horizontal and vertical positions for each display element on the browser are maintained as associated data elements. For example, the vertical position of a particular display element is maintained as a corresponding top_offset data element, associated with the particular display element, that indicates the element's vertical offset from the top edge of the display area of the browser. In embodiments where the tabs are to be re-arranged so that right-most tabs in a first row are re-positioned to the left-most position of the row of tabs above the first row, the browser's computed new horizontal position of the tabs (i.e., at the left most position of the line to which the tabs are line-wrapped) will reflect the correct horizontal positions of the tabs. However, the new vertical positions, as computed by the browser, for the shifted elements will be incorrect and will have to be adjusted.

Thus, having determined the new vertical and horizontal positions computed by the browser (for example, by retrieving the respective computed top_offset values of the tabs to be repositioned), the procedure 500 adjusts at 530 the vertical positions of the tabs elements to be displayed in the browser. In embodiments where line-wrapped tabs are to be positioned in the above row, the top_offset value for each of the tab elements is re-adjusted according to a suitable positioning scheme. For example, in some embodiments, the new vertical offset value computed by the browser for the tab elements is re-adjusted according to a negative inverse proportion scheme. Particularly, because the browser will ordinarily cause tab elements to be positioned below their original lines, the new vertical positions of tab elements, as computed by the browser, will be farther away from the top edge of the display area of the browser. In other words, the computed top_offset value will increase (e.g., going from 3 to 4 inches as computed with respect to a point-of-origin positioned at the top-left corner of the browser). Thus, to determine what adjustment needs to be performed on the top_offset value so that the tab element is in fact is placed in a position closer to the top edge of the display area of the browser, a new value that is inversely proportional to the difference in the new and old top_offset values, as computed by the browser, is determined. For example, suppose a tab element has an initial top_offset value of 6 in, and the browser computes a new top_offset value of 8 in response to a re-sizing operation. The procedure 500, using the negative inversely proportional scheme, could adjust the top_offset value 4 in. If, however, the top_offset value computed by the browser is 10 in, the re-adjusted value, as determined using the procedure 500, may be 2 in.

Alternatively, other adjustment schemes may be performed to compute the vertical positions of the various line wrapped tab elements.

After determining the new position in the browser of any line-wrapped tab element, the browser uses the adjusted position values of the tab elements, as determined by the procedure 500, to present the tab elements in the display area of the browser.

Appendix A, provided herein, includes exemplary Javascript code, as well as the accompanying Cascading Style Sheet definitions for implementing the procedure 500 on Microsoft Internet Explorer™. Other implementations for computing and adjusting the tabs' positions, including implementations for use with other application software operating on different operating systems, may be developed.

Where other tools, platforms and/or operating systems for running graphical user interfaces are used to present the graphical interface, suitable techniques for displaying line-wrapped tabs so that they maintain their relative positions with respect to the other tabs, may be used.

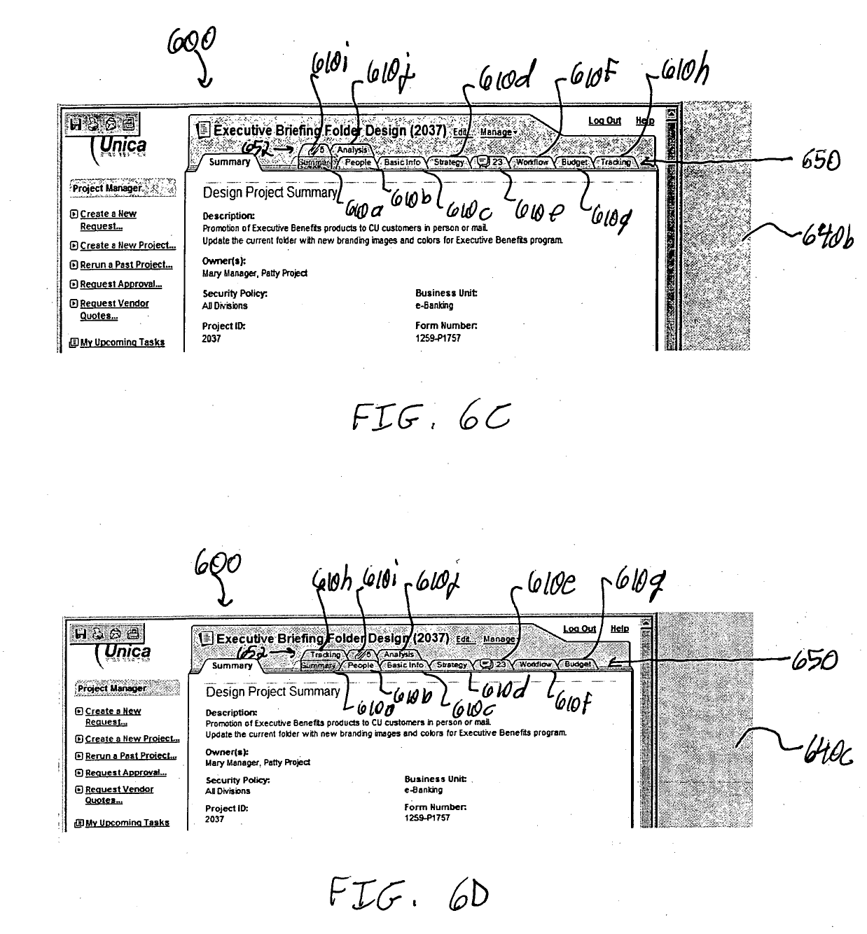

FIGS. 6A-6D show an exemplary embodiment of an interface 600 being re-sized and having its respective tabs re-positioned using, for example, the procedure 500 described herein. FIG. 6A shows the exemplary interface 600 having a first size. As can be seen, the interface 600 includes a first area 612 (i.e., the tabs area) where the various tabs 610a-610j available on the interface are presented. The tabs area 612 also has a first size which is determined at least partly by the size of the interface. Thus, re-sizing of the interface 600 can also cause the tabs area 612 to be re-sized. Additionally, the particular size of the area 612 may also be controlled by setting interface parameters to specify a particular size for the tabs area 612 and/or any other area of the interface 600.

The tab 610a, identified as “Summary” is the selected tab, and accordingly that tab appears less opaque (and thus more transparent and faded) than the other tabs 610b-610j. Additionally, a copy of the selected tab is presented as tab 620 in a second area 622 of the interface 600. The set of data items 630 associated with the Summary tab is presented in a third area 632 of the interface 600.

FIG. 6B shows the interface 600 after a re-sizing operation had been performed on the interface. The shaded area 640a represents an area on a display device (not shown) on which the interface 600 is presented that is no longer occupied as a result of the re-sizing operation. As shown, the tab 610j, identified as “Analysis”, which in the interface's first size (as shown in FIG. 6A) was located at the right-most position of the single row of tabs, has moved to the left-most position of a new row of tabs 652 located immediately above the first row of tab 650.

FIGS. 6C and 6D show the interface 600 after two further resizing operations have been performed on the interface 600. As shown in FIG. 6C, a re-sizing operation further reduces the size of interface 600 so that a bigger area of the display area of the display device, marked as 640b, is no longer occupied by the graphical interface 600. Consequently, the size of the tabs area also decreases as the tabs are re-positioned. Specifically, the re-sizing operation causes what was the right-most tab for the tabs area shown in FIG. 6B, namely, tab 610i, identified as “Paperclip 5”, to be wrapped around to the left most position of the second row of tabs. The Analysis tab 610j is consequently moved to the right, thereby maintaining its sequential position relative to the Paperclip 5 tab 610i.

As shown in FIG. 6D, after a further re-sizing operation has been performed, resulting in a smaller tabs area for presenting the tabs 610a-610j of interface 600 (as indicated by the increased size of the shaded area 640c relative to the shaded area 640a and 640b of FIGS. 6B and 6C respectively), the right-most tab 610h of FIG. 6C, identified as the “Tracking” tab, is wrapped around to the left-most position of the second row 652. As a result, the Paperclip 5 tab 610i and Analysis tab 610j are moved to the right of the Tracking tab 610h, and continue to maintain their relative sequential position vis-à-vis Tracking tab 610h, as well as their relative positions with respect to the other tabs 610a-610g.

Although FIGS. 6A-6D show a gradual re-sizing of interface 600 that results in a gradual re-positioning of the tabs presented in tabs area 612, a single re-sizing operation can adjust the size of the interface 600 to any arbitrary size (subject to any constraints that may be specified with respect to the interface, including constraints specifying a minimum interface size). The adjustment of the interface 600 to an arbitrary size will result in a corresponding re-positioning of the tabs of the interface. Thus, for example, interface 600 can be re-sized from its first size shown in FIG. 6A to the size shown in FIG. 6D in a single operation, thereby causing tabs 610h-610j to be re-positioned into the upper tabs row 652 shown in FIG. 6D.

In other embodiments, other tab re-positioning schemes can be used. For example, the wrapping around and shifting of tabs can be performed so that tabs on a right-end of a row will be moved to the right-end of the row above, with the tab being at the right-most end of the first row being re-positioned to occupy a position immediately to the right of the previously right-most tab of the above row (i.e., the tab that prior to the re-positioning operation occupied the right-most position of the above row).

### Other Embodiments

A number of embodiments of the invention have been described. Nevertheless, it will be understood that various modifications may be made without departing from the spirit and scope of the invention. Accordingly, other embodiments are within the scope of the following claims.

APPENDIX A

```
Java Script Implementation of the Tabs Re-sizing procedure
    var alreadyStarted = false;
    var almostDone = false;
    var done = false;
    function attemptToWrapTabs( ) {  // kick off the
polling function if it hasn't already been kicked off
    try {
        if (!alreadyStarted) {
            alreadyStarted=true;
            repeatCallsToWrapTabs( );
        } else {
            almostDone=false;
            done=false;
        }
    } catch(err) {
        done = false;
        almostDone = false;
        alreadyStarted = false;
    }
    }
    function repeatCallsToWrapTabs( ) {  // polling function that
knows how to call wrapTabs periodically during a window resize, and then once more
after the resize is complete
    try {
        if (!done) {
            wrapTabs( );
            setTimeout(“repeatCallsToWrapTabs( )”,250);
            if (almostDone==true) {
                done = true;
            } else {
                almostDone = true;
            }
        } else {
            done = false;
            almostDone = false;
            alreadyStarted = false;
        }
    } catch(err) {
        done = false;
        almostDone = false;
        alreadyStarted = false;
    }
    }
    function wrapTabs( ) {  // function that
actually contains the tab wrapping logic
    // initialize constants the determine the tab dimensions and spacing
    var tabHeight = 14;
    var tabRowSpacing = 2;
    var tabSlantWidth = 12;
    // get a handle to the html elements for the tabs
    var ulObj = document.getElementById(“objectTabs”);
    var tabObjArr = ulObj.getElementsByTagName(‘LI’);
    // reset all positioning to the browser's default line wrapping behaviors
    for (var i=0; i<tabObjArr.length; i++) {
        tabObjArr[i].style.position = “ ”;
        tabObjArr[i].style.top = “ ”;
        tabObjArr[i].style.left = “ ”;
        tabObjArr[i].style.height = tabHeight + “px”;
    }
    // loop through the tabs setting our new custom positioning
    var oldStartingY = tabObjArr[0].offsetTop;  // the y-value assigned to the line
wrapping tabs by the browser's default behavior
    var currRowHeight = tabHeight;  // each row height
must be the distance from the top of a tab in that row to the bottom of a tab in the lowest
row
    var currRowTopOffset = 0;  // each row is
relatively positioned upward the distance of its height plus the height of the rows below it
    var leftOffsetToUse = 0;  // horizontal spacing
between the left edge of a row and the row above it, creating a pyramid-like stacking of
line-wrapped tabs
    for (var i=0; i<tabObjArr.length; i++) {
        // see if this tab is the start of a new row
        if (oldStartingY!=tabObjArr[i].offsetTop) {
            oldStartingY=tabObjArr[i].offsetTop;
            currRowHeight+=tabHeight;
            currRowTopOffset−=currRowHeight;
            leftOffsetToUse+=tabSlantWidth;
        }
        // set the dimensions and positioning of the current tab using css, to make
this row appear above the previous ones instead of below it
        tabObjArr[i].style.position = “relative”;
        tabObjArr[i].style.height = currRowHeight+“px”;
        tabObjArr[i].style.top = currRowTopOffset;
        tabObjArr[i].style.left = leftOffsetToUse;
        tabObjArr[i].style.zIndex = 1000−i;
    }
    // set the dimensions and positioning of the entire tab set using css, to make it
align with the top of the sheet of faux paper
    ulObj.style.position = “relative”;
    ulObj.style.top = (tabRowSpacing−tabHeight+currRowHeight) + “px”;
    ulObj.parentNode.style.height = ((2*tabRowSpacing)+currRowHeight) + “px”;
    ulObj.parentNode.style.overflow=“hidden”;
    ulObj.parentNode.style.backgroundPosition=“right”+(currRowHeight−
tabRowSpacing)+“px”;
    // set the dimensions and positioning of the pulled out selected tab to make it align
with the top of the sheet of faux paper
    document.getElementById(“selectedTabCaption”).style.top = (currRowHeight) +
“px”;
    }
    window.onload = wrapTabs;
    window.onresize = attemptToWrapTabs;
Cascading Style Sheet for the Tabs
    /* General appearance of the page, removing margins and setting the fonts and
colors */
    html {height:100%; width:100%;}
    body {height:100%; margin:9px; margin-bottom:0px; font-family:Arial; font-
size:.7em;}
    a {color:#00508A;}
    a:hover {color:#ff3300; text-decoration:underline;}
    /* Setting up the faux paper look, putting edges and borders where they belong */
    .objectPageWrapper {height:100%; background-color:#ffffff; margin-left:10px;}
    .objectManagementInteractions {display:block; height:16px;
background:url(images/img_paperTopEdges.gif) repeat-x bottom left;}
    .objectManagementInteractions span.wrapper {display:block; padding-left:125px;
height:100%; background:url(images/img_paperTopEdge_Left.gif) no-repeat bottom
left;}
    div.objectTabLinks {display:block; height:100%;
background:url(images/img_paperTopEdge_Right.gif) no-repeat bottom right; padding-
right:15px;}
    .objectPageContents {height:100%; border:1px #000000 solid; border-width:1px
3px 0px 1px; margin:0px; padding:20px; padding-top:12px;}
    /* Give the list items text-like line wrapping behavior using floats, and give them
tab-like appearance using background images */
    div.objectTabLinks ul {
        display:block;
        margin:0px;
        padding:0px;
    }
    div.objectTabLinks ul li {
        background:url(images/img_tab_unselectedL.gif) no-repeat top left;
        display:block;
        float:left;
        margin-right:1px;
        margin-left:4px;
        padding-left:2px;
        height:14px;
    }
    div.objectTabLinks ul li a {
        display:block;
        font-size:10px;
        text-decoration:none;
        position:relative;
        left:10;
        padding-right:10px;
        height:100%;
        background:url(images/img_tab_unselectedR.gif) no-repeat top right;
    }
    * html div.objectTabLinks ul li a {  /* IE-only, to prevent wrapping of text
within the tabs */
        width:10px;
        white-space:nowrap;
    }
    /* Make the selected tab appear partially transparent */
    div.objectTabLinks ul li.selected {
        background-image:url(images/img_tab_fadedL.gif);
        filter:alpha(opacity=25);
        -moz-opacity:.25;
    }
    div.objectTabLinks ul li.selected a {
        background-image:url(images/img_tab_fadedR.gif);
        color:#000000;
    }
    div.objectTabLinks ul li.selected a:hover {
        text-decoration:none;
    }
    * html div.objectTabLinks ul li.selected {  /* IE-only */
        filter:alpha(opacity=25);
        margin-right:−10;
    }
    * html div.objectTabLinks ul li.selected a {  /* IE-only */
        background-image:url(images/img_tab_fadedR-IE.gif);
        margin-right:10;
        color:#000000;
    }
    /* Styling the pulled-out tab header with background images to make it look like a
tab, and positioning it */
    .objectManagementInteractions span#selectedTabCaption {
        z-index:20;
        float:left;
        position:absolute;
        left:27;
        height:20px;
        margin-top:−6px;
        padding-left:4px;
        background:url(images/img_tab_selectedL.gif) no-repeat top left;
        font-weight:bold;
    }
    .objectManagementInteractions span#selectedTabCaption div {
        display:block;
        height:100%;
        background:url(images/img_tab_selectedR.gif) no-repeat top right;
        font-size:11px;
        color:#000000;
        text-decoration:none;
        padding-top:2px;
        padding-right:18px;
        position:relative;
        left:15;
    }
    .objectManagementInteractions span#selectedTabCaption a {
        color:#000000;
        text-decoration:none;
    }
    * html .objectManagementInteractions span#selectedTabCaption { /* IE-only */
        width:10px;
        white-space:nowrap;
    }
```

What is claimed is:

1. A method comprising:
presenting in a first area of a graphical interface a plurality of graphical items arranged in one or more sequences of graphical items, each of the graphical items associated with a set of data items, With the plurality of graphical items arranged in a fixed relative order for a particular size of the first area, with a first graphical item in one sequence always being spatially adjacent to a second graphical item in the one sequence, and with another sequence of the one or more sequences of graphical items being spatially adjacent to the same sequence of graphical items preceding the another sequence of graphical items.

2. The method of claim 1 further comprising:
presenting a copy of the selected graphical item in a second area of the graphical interface in response to a selection of one of the plurality of graphical items.

3. The method of claim 2 further comprising:
indicating that the selected graphical item has been selected.

4. The method of claim 3, wherein each of the plurality of the graphical items is associated with a corresponding opaqueness value, and wherein indicating that the selected graphical item in the first area of the graphical interface has been selected includes:
changing the opaqueness value associated with the selected graphical item.

5. The method of claim 4, wherein changing the opaqueness value associated with the selected graphical item includes decreasing the opaqueness value.

6. The method of claim 1, wherein each of the plurality of graphical items is represented as a corresponding tab.

7. The method of claim 6, wherein the one or more sequences of graphical items are represented as rows of tabs.

8. The method of claim 2, further comprising
presenting in a third area of the graphical interface, in response to the selection of the one of the plurality of graphical items, the corresponding set of data items associated with the selected graphical item, wherein the copy of the selected graphical item presented in the second area of the graphical interface and the corresponding set of data items presented in the third area are represented as a page having a tab.

9. The method of claim 1, wherein each corresponding set of data items includes at least one of: a text paragraph, a hyperlink, an image, a text entry field, and a graphical radio button.

10. The method of claim 1, further comprising:
in response to a re-sizing operation performed on the interface, causing one or more graphical items to be re-positioned, with the respective relative sequential positions of the graphical items, following a particular path that starts from a particular graphical item, remaining fixed.

11. The method of claim 10, wherein presenting comprises displaying in a display area of an Internet browser, and wherein causing one or more graphical items to be re-positioned comprises:
a) detecting an occurrence of a browser re-sizing event;
b) determining the coordinates of the one or more graphical items to be re-positioned computed by the browser; and
c) adjusting the respective coordinates for at least some of the one or more graphical items to be re-positioned.

12. The method of claim 10, wherein the path includes at least one of: a row-by row progression, a column-by-column progression.

13. The method of claim 1, further comprising:
in response to performing a re-sizing operation on the graphical interface, causing one or more graphical items positioned at the end of a particular sequence of graphical items to be positioned at the beginning of another sequence of graphical items positioned adjacent to the particular sequence of graphical items.

14. The method of claim 13, wherein the one or more sequences of graphical items are represented as rows of tabs, and wherein causing the one or more graphical items positioned at the end of a particular sequence of graphical items to be positioned at the beginning of another sequence of graphical items includes:
causing one or more tabs positioned at the right-end of the particular row of tabs to be positioned at the left-end of a row of tabs located above the particular row of tabs.

15. A method comprising:
presenting in a first area of a graphical-user-interface (GUI) a plurality of tabs arranged in one or more rows of tabs, each of the tabs associated with a corresponding set of data items, with the plurality of tabs arranged in a fixed relative order to each other for a particular size of the first area, with a tab in one row always being spatially adjacent to a second tab in the one row, and with another row of the one or more rows of tabs being spatially adjacent to the same row of tabs preceding the another row of tabs.

16. The method of claim 15 further comprising:
in response to a selection of one of the plurality of tabs, presenting a copy of the selected tab in a second area of the GUI.

17. The method of claim 16 further comprising:
indicating that the selected tab has been selected.

18. The method of claim 17, wherein each of the plurality of the tabs is associated with a corresponding opaqueness value, and wherein indicating that the selected tab in the first area of the GUI has been selected includes changing the opaqueness value associated with the selected tab.

19. The method of claim 18, wherein changing the opaqueness value associated with the selected tab includes decreasing the opaqueness value.

20. The method of claim 16, further comprising
presenting in a third area of the GUI, in response to the selection of the one of the plurality of tabs, the corresponding set of data items associated with the selected tab, wherein the copy of the selected tab presented in the second area of the GUI and the corresponding set of data items presented in the third area are represented as a page having a tab.

21. The method of claim 15, wherein each corresponding set of data items includes at least one of: a text paragraph, a hyperlink, an image, a text entry field, and a graphical radio button.

22. The method of claim 15, further comprising:
in response to a re-sizing operation performed on the graphical interface, causing one or more of the plurality tabs to be re-positioned, with the respective relative sequential positions of the one or more of the plurality of tabs, following a particular path that starts from a particular tab, remaining fixed.

23. The method of claim 22, wherein presenting comprises displaying in a display area of an Internet browser, and wherein causing one or more of the plurality of tabs to be re-positioned comprises:
a) detecting an occurrence of a browser re-sizing event;
b) determining the coordinates of the one or more of the plurality of tabs to be re-positioned computed by the browser; and
c) adjusting the respective coordinates for at least some of the one or more of the plurality of tabs to be re-positioned.

24. The method of claim 22, wherein the path includes at least one of: a row-by row progression, a column-by-column progression.

25. The method of claim 15, further comprising:
in response to performing a re-sizing operation on the GUI, causing one or more of the tabs positioned at the end of a particular row of tabs to be positioned at the beginning of another row of tabs positioned adjacent to the particular row of tabs.

26. The method of claim 25, wherein causing the one or more tabs positioned at the end of a particular row of tabs to be positioned at the beginning of another row of tabs includes:
causing one or more tabs positioned at the right-end of the particular row of tabs to be positioned at the left-end of a row of tabs located above the particular row of tabs.

27. The method of claim 16, wherein the second area is positioned at least one of: to the left the first area of the GUI where the one or more rows of tabs are located, and to the right of the first area of the GUI where the one or more rows of tabs are located.

28. A computer program product residing on a machine-readable storage medium for storing computer instructions that, when executed, cause a processor-based machine to:
present in a first area of a graphical interface a plurality of graphical items arranged in one or more sequences of graphical items, each of the graphical items associated with a set of data items, with the plurality of graphical items arranged in a fixed relative order for a particular size of the first area, with a first graphical item in one sequence always being spatially adjacent to a second graphical item in the one sequence, and with another sequence of the one or more sequences of graphical items being spatially adjacent to the same sequence of graphical items preceding the another sequence of graphical items.

29. The computer program product of claim 28, further comprising instructions that cause the processor-based machine to:
present a copy of the selected graphical item in a second area of the graphical interface in response to a selection of one of the plurality of graphical items.

30. The computer program product of claim 28, wherein each of the plurality of graphical items is represented as a corresponding tab.

31. The computer program product of claim 28, further comprising instructions that cause the processor-based machine to:
in response to a re-sizing operation performed on the graphical interface, cause one or more graphical items to be re-positioned, with the respective relative sequential positions of the graphical items, following a particular path that starts from a particular graphical item, remaining fixed.

32. The computer program product of claim 31, wherein the computer instructions that cause the processor-based machine to present comprise computer instructions that cause the processor-based machine to display in a display area of an Internet browser, and wherein the computer instructions that cause the processor-based machine to cause one or more graphical items to be re-positioned comprise computer instructions that cause the processor-based machine to:
a) detect an occurrence of a browser re-sizing event;
b) determine the coordinates of the one or more graphical items to be re-positioned computed by the browser; and
c) adjust the respective coordinates for at least some of the one or more graphical items to be re-positioned.

33. A system comprising:
a display device;
a memory module configured for storing instructions; and
a processor configured to fetch and execute the instructions, and, in response to executing the instructions:
present in a first area of a graphical interface a plurality of graphical items arranged in one or more sequences of graphical items, each of the graphical items associated with a set of data items, with the plurality of graphical items arranged in a fixed relative order for a particular size of the first area, with a first graphical item in one sequence always being spatially adjacent to a second graphical item in the one sequence, and with another sequence of the one or more sequences of graphical items being spatially adjacent to the same sequence of graphical items preceding the another sequence of graphical items.

34. The system of claim 33, wherein the processor, in response to executing the instruction, is further configured to:
present a copy of the selected graphical item in a second area of the graphical interface in response to a selection of one of the plurality of graphical items.

35. The system of claim 33, wherein each of the plurality of graphical items is represented as a corresponding tab.

36. The system of claim 33, wherein the processor is further configured to:
in response to a re-sizing operation performed on the graphical interface, cause one or more graphical items to be re-positioned, with the respective relative sequential positions of the graphical items, following a particular path that starts from a particular graphical item, remaining fixed.

37. The system of claim 36, wherein the processor configured to present is further configured to display in a display area of an Internet browser, and wherein the processor configured to cause one or more graphical items to be re-positioned is further configured to:
a) detect an occurrence of a browser re-sizing event;
b) determine the coordinates of the one or more graphical items to be re-positioned computed by the browser; and
c) adjust the respective coordinates for at least some of the one or more graphical items to be re-positioned.
